(19) United States
(12) Patent Application Publication
(10) Pub. No.: US 2025/0187684 A1
(43) Pub. Date: Jun. 12, 2025

(54) APPARATUS FOR COMBINING VEHICLE COMPONENTS

(71) Applicants: HYUNDAI MOTOR COMPANY, Seoul (KR); KIA CORPORATION, Seoul (KR)

(72) Inventors: Hyeon Cheol Choi, Yongin-si (KR); Byung Yoon Kim, Gwangju-si (KR); In June Kim, Suwon-si (KR); Myung Gun Kim, Suwon-si (KR)

(73) Assignees: HYUNDAI MOTOR COMPANY, Seoul (KR); KIA CORPORATION, Seoul (KR)

(21) Appl. No.: 18/635,732

(22) Filed: Apr. 15, 2024

(30) Foreign Application Priority Data
Dec. 8, 2023 (KR) 10-2023-0178072

(51) Int. Cl. B62D 65/06; B29C 65/14; B29C 65/48; B29C 65/78; B29L 31/30; B62D 65/16

(52) U.S. Cl. CPC B62D 65/06; B29C 65/1412; B29C 65/4835; B29C 65/7847; B62D 65/16; B29L 2031/3055

(57) ABSTRACT

An apparatus for combining vehicle components includes: a base frame; a pressing part provided on the base frame and configured to press a bonding target component against a vehicle body so that a bonding layer applied onto the bonding target component comes into close contact with the vehicle body; and a heating part provided on the base frame and configured to heat the bonding layer to cure the bonding layer. As a result, the apparatus obtains advantageous effects of improving quality, productivity, and production efficiency.

### CROSS-REFERENCE TO RELATED APPLICATION

This application claims priority to and the benefit of Korean Patent Application No. 10-2023-0178072 filed in the Korean Intellectual Property Office on Dec. 8, 2023, the entire contents of which are incorporated herein by reference.

### TECHNICAL FIELD

The present disclosure relates to an apparatus for combining vehicle components, and more particularly, to an apparatus for combining vehicle components, which is capable of improving quality, productivity, and production efficiency.

### BACKGROUND ART

With the recent focus on environmental issues, various attempts have been made to improve fuel economy efficiency of a vehicle by reducing the weight of the vehicle.

In general, because a vehicle body of the vehicle accounts for about 30% of the total weight of the vehicle, it is possible to improve fuel economy efficiency of the vehicle by reducing the weight of the vehicle.

For example, a roof of the vehicle body accounts for a significant proportion of the total weight of the vehicle body. In the related art, a roof panel made of steel is applied to ensure safety, and the roof panel made of steel may ensure sufficient rigidity. However, there is a problem in that the heavy weight of the roof panel degrades the fuel economy efficiency of the vehicle.

Therefore, recently, attempts have been made to reduce the weight while maintaining the rigidity of the vehicle body by manufacturing some (e.g., a roof panel or a door) of the components, which constitute the vehicle body, by using lightweight composite materials such as carbon fiber reinforced plastic (CFRP).

In general, the composite material components may be joined (coupled) to the vehicle body by means of a bonding agent.

However, in the related art, because the process of joining the composite material components to the vehicle body by using the bonding agent is performed at room temperature, there is a problem in that it is difficult to ensure the joining quality between the composite material component and the vehicle body, and a large amount of time (e.g., one hour) is required to cure the bonding agent. For these reasons, there is a problem in that productivity and production efficiency deteriorate.

Moreover, in case that subsequent processes (e.g., subsequent assembling processes) are performed in a state in which the bonding agent is not sufficiently cured, there is a problem in that bonded portions between the vehicle body and the composite material are deformed, or the bonding quality of the bonded portions deteriorates.

Therefore, recently, various studies have been conducted to ensure the joining quality between the composite material component and the vehicle body and improve productivity and production efficiency, but the study results are still insufficient. Accordingly, there is a need to develop a technology to ensure the joining quality between the composite material component and the vehicle body and improve productivity and production efficiency.

### SUMMARY

The present disclosure has been made to provide an apparatus for combining vehicle components, which is capable of improving quality, productivity, and production efficiency.

In particular, the present disclosure has been made to simplify a joining process while ensuring joining quality between a composite material component and a vehicle body.

Among other things, the present disclosure has been made to allow the single apparatus for combining vehicle components to perform both a process of pressing the composite material component against the vehicle body and a process of heating a bonding layer.

The present disclosure has also been made in an effort to simplify a structure and a manufacturing process and improve spatial utilization and a degree of design freedom.

The present disclosure has also been made to shorten the time required for a process of joining the composite material component to the vehicle body and to reduce the manufacturing costs.

The present disclosure has also been made to reduce a defect rate and improve durability and reliability.

The objects to be achieved by the embodiments are not limited to the above-mentioned objects. Other objects or effects may be understood from the solutions or embodiments described below.

In order to achieve the above-mentioned objects, the present disclosure provides an apparatus for combining vehicle components. The apparatus includes a base frame and a pressing part provided on the base frame. The pressing part is configured to press a bonding target component against a vehicle body so that a bonding layer applied onto the bonding target component comes into close contact with the vehicle body. The apparatus also includes a heating part provided on the base frame and configured to heat the bonding layer such as to cure the bonding layer.

This apparatus is to improve quality, productivity, and production efficiency.

In other words, in the related art, because the process of joining the composite material components (bonding target component) to the vehicle body by using the bonding agent is performed at room temperature, there is a problem in that it is difficult to ensure the joining quality between the composite material component and the vehicle body. Additionally, a large amount of time (e.g., one hour) is required to cure the bonding agent. For this reason, there is a problem in that productivity and production efficiency deteriorate. Moreover, in case that subsequent processes (e.g., subsequent assembling processes) are performed in a state in which the bonding agent is not sufficiently cured, there is a problem in that bonded portions between the vehicle body and the composite material are deformed, or the bonding quality of the bonded portions deteriorates.

In contrast, in the embodiment of the present disclosure, the bonding layer applied between the bonding target component and the vehicle body is simultaneously pressed between the bonding target component and the vehicle body and heated by the heating part. Therefore, it is possible to obtain an advantageous effect of improving productivity and production efficiency while ensuring the joining quality between the bonding target component and the vehicle body.

Among other things, in the embodiment of the present disclosure, the bonding layer for joining the bonding target component and the vehicle body is forcibly cured by the heat from the heating part without being cured at room temperature. Therefore, it is possible to obtain an advantageous effect of shortening the time required to cure the bonding layer and minimizing the deformation of the bonded portion between the bonding target component and the vehicle body during the subsequent process.

Moreover, in an embodiment of the present disclosure, the single apparatus for combining vehicle components performs both the process of pressing the composite material component (bonding target component) against the vehicle body and the process of heating (curing) the bonding layer. Therefore, it is possible to obtain advantageous effects of simplifying the structure and manufacturing process and improving the spatial utilization and degree of design freedom.

According to an embodiment of the present disclosure, the pressing part may include a pressing frame connected to the base frame and a pressing block provided on the pressing frame and configured to come into contact with the bonding target component. The pressing block may be configured to transmit the weight of the base frame to the bonding target component.

According to an embodiment of the present disclosure, the bonding layer may be provided along an outermost peripheral edge of the bonding target component. The pressing block may be configured to press an outermost peripheral edge portion of the bonding target component corresponding to the bonding layer.

According to an embodiment of the present disclosure, the pressing part may include a pressing clamp provided on the base frame and configured to be movable from a pressing standby position at which the pressing clamp is spaced apart from the bonding target component to a pressing position at which the pressing clamp presses the bonding target component. The pressing part may also include a pressing block provided on the pressing clamp and configured to come into contact with the bonding target component. The pressing block may be configured to press the bonding target component against the vehicle body with the bonding layer interposed therebetween.

According to an embodiment of the present disclosure, the apparatus may include a clamp latch configured to support the pressing clamp on the base frame so that the pressing clamp is rotatable. The pressing clamp may be configured to rotate about one end of the clamp latch from the pressing standby position to the pressing position.

According to an embodiment of the present disclosure, the pressing block may press the bonding target component at a position spaced apart from an outermost peripheral edge of the bonding target component at a preset reference distance. and The heating part may heat the bonding layer in a region between the outermost peripheral edge of the bonding target component and the pressing block.

According to an embodiment of the present disclosure, the heating part may include a heat source configured to emit heat for heating the bonding layer and a support member connected to the base frame and configured to support the heat source.

According to an embodiment of the present disclosure, the heat source may include an infrared lamp.

According to an embodiment of the present disclosure, the apparatus may include a light collecting part configured to collect infrared rays, which are emitted from the infrared lamp, toward the bonding layer.

According to an embodiment of the present disclosure, the heating part may be configured to be selectively movable from a heating standby position at which the heating part is spaced apart from the bonding target component to a heating position at which the heating part is adjacent to the bonding target component.

According to an embodiment of the present disclosure, the apparatus may include: a link member configured to support the heating part on the base frame so that the heating part is rotatable. A posture of the heating part with respect to the bonding target component is selectively adjusted based on a rotation of the link member relative to the base frame.

According to an embodiment of the present disclosure, the heating part may be configured to heat the vehicle body adjacent to the bonding layer and the bonding layer may be heated by heat conducted from the vehicle body.

According to an embodiment of the present disclosure, the apparatus may include a sensing part configured to sense a heating temperature of the bonding layer heated by the heating part.

According to an embodiment of the present disclosure, the apparatus may include an alarm generating part configured to generate an alarm signal when the heating temperature of the bonding layer sensed by the sensing part deviates from a preset reference temperature.

According to an embodiment of the present disclosure, the apparatus may include a grip part provided on the base frame and configured to grip the bonding target component.

According to an embodiment of the present disclosure, the grip part may include a suction gripper configured to hold an outer surface of the bonding target component by suction.

According to an embodiment of the present disclosure, the apparatus may include a seating part provided on the base frame and configured such that the vehicle body is seated on the seating part.

According to an embodiment of the present disclosure, the seating part may include a plurality of locators disposed to be spaced apart from one another along an edge of the vehicle body.

According to an embodiment of the present disclosure, the bonding target component may include a roof panel configured to define a roof of the vehicle body.

According to an embodiment of the present disclosure, the bonding target component may include a door panel configured to define a door of the vehicle body.

### BRIEF DESCRIPTION OF THE DRAWINGS

FIG. 1 is a view illustrating a system for combining vehicle components to which an apparatus for combining vehicle components according to an embodiment of the present disclosure is applied.

FIG. 2 is a perspective view illustrating an apparatus for combining vehicle components according to an embodiment of the present disclosure.

FIG. 3 is a view illustrating a bonding target component related to an apparatus for combining vehicle components according to an embodiment of the present disclosure.

FIG. 4 is a top plan view of an apparatus for combining vehicle components according to an embodiment of the present disclosure.

FIG. 5 is a side view of an apparatus for combining vehicle components according to an embodiment of the present disclosure.

FIGS. 6 and 7 are views illustrating a pressing part of an apparatus for combining vehicle components according to an embodiment of the present disclosure.

FIG. 8 is a view illustrating a grip part of an apparatus for combining vehicle components according to an embodiment of the present disclosure.

FIG. 9 is a view illustrating a heating part of an apparatus for combining vehicle components according to an embodiment of the present disclosure.

FIGS. 10-13 are views illustrating a process of heating a bonding layer by using a heating part of an apparatus for combining vehicle components according to an embodiment of the present disclosure.

FIG. 14 is a perspective view illustrating an apparatus for combining vehicle components according to another embodiment of the present disclosure.

FIG. 15 is a top plan view of an apparatus for combining vehicle components according to another embodiment of the present disclosure.

FIGS. 16 and 17 are views illustrating a seating part of an apparatus for combining vehicle components according to another embodiment of the present disclosure.

FIG. 18 is a perspective view illustrating a pressing part of an apparatus for combining vehicle components according to another embodiment of the present disclosure.

FIG. 19 is a perspective view illustrating a heating part of an apparatus for combining vehicle components according to another embodiment of the present disclosure.

FIG. 20 is a view illustrating a process of heating a bonding layer by using a heating part of an apparatus for combining vehicle components according to another embodiment of the present disclosure.

FIG. 21 is a view illustrating a light collecting part of an apparatus for combining vehicle components according to an embodiment of the present disclosure.

FIG. 22 is a view illustrating a modified example of a base frame of an apparatus for combining vehicle components according to an embodiment of the present disclosure.

### DETAILED DESCRIPTION

Hereinafter, embodiments of the present disclosure are described in detail with reference to the accompanying drawings.

However, the technical spirit of the present disclosure is not limited to the embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as having meanings which may be commonly understood by a person having ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present disclosure, unless particularly stated otherwise, a singular form may also include a plural form. The expressions “at least one (or one or more) of A, B, and C” and “at least one of A, B, or C” may include any one of the elements A, B, or C or may include any one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, it should be understood that one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

When a component, device, element, or the like of the present disclosure is described as having a purpose or performing an operation, function, or the like, the component, device, or element should be considered herein as being “configured to” meet that purpose or perform that operation or function.

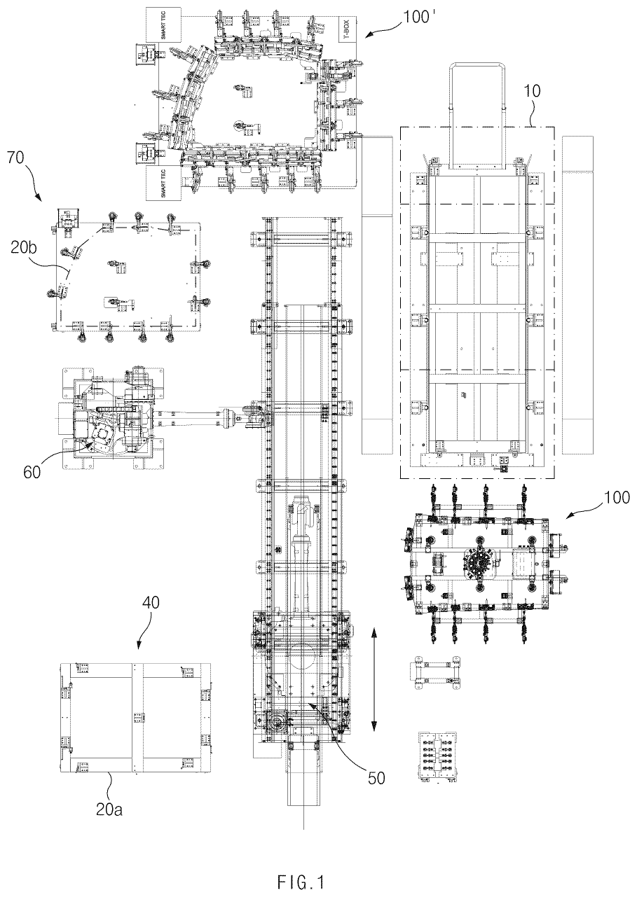

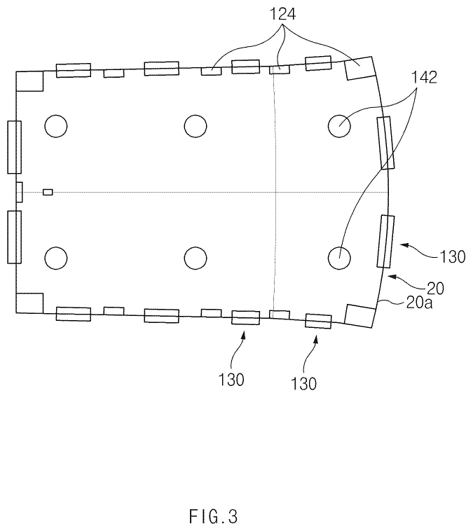

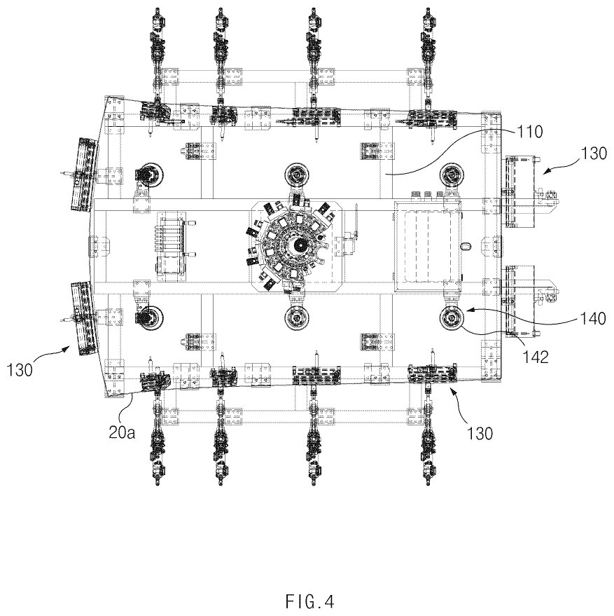

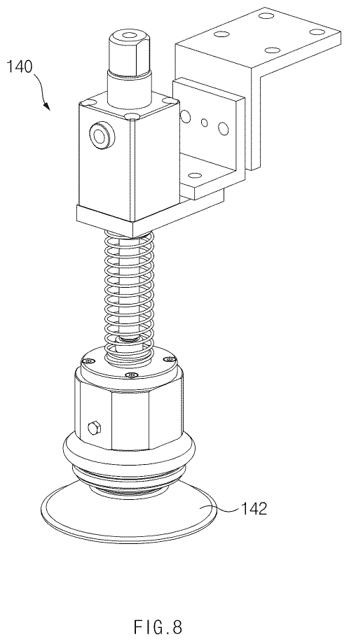

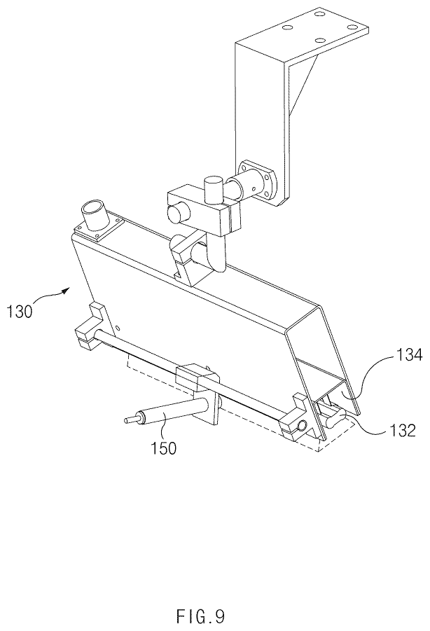

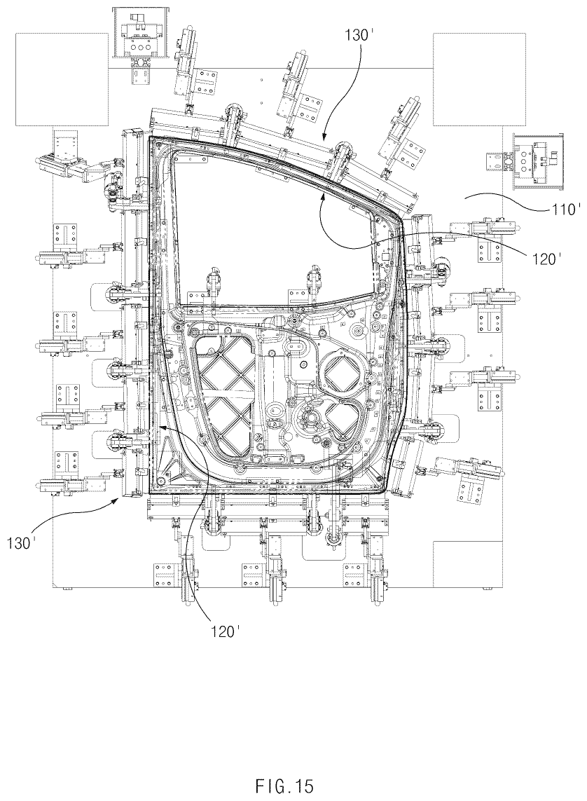

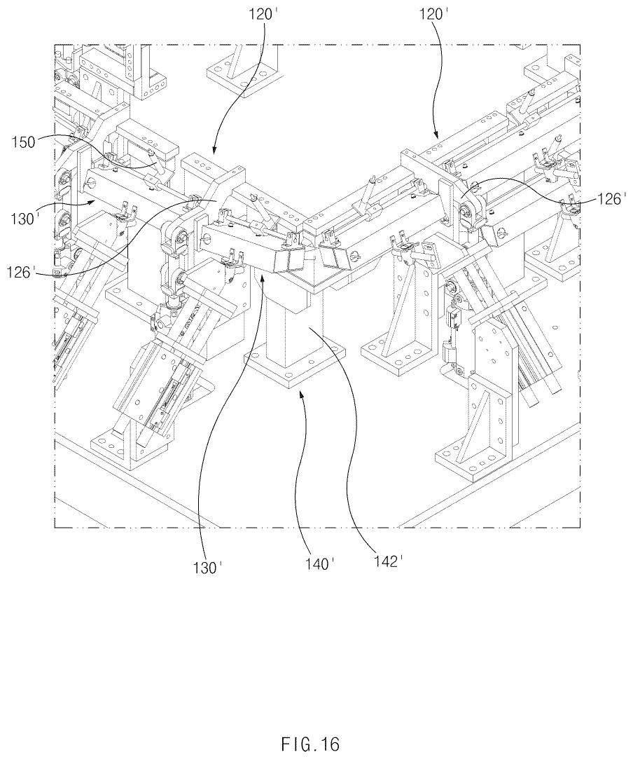

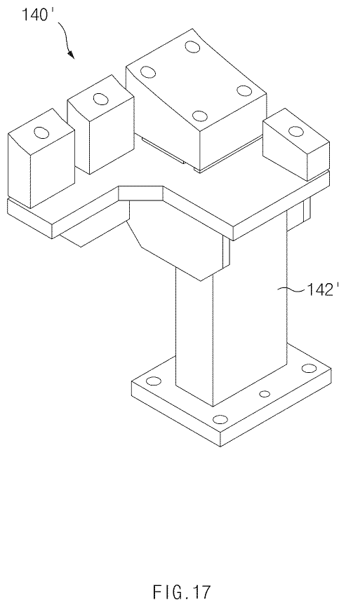

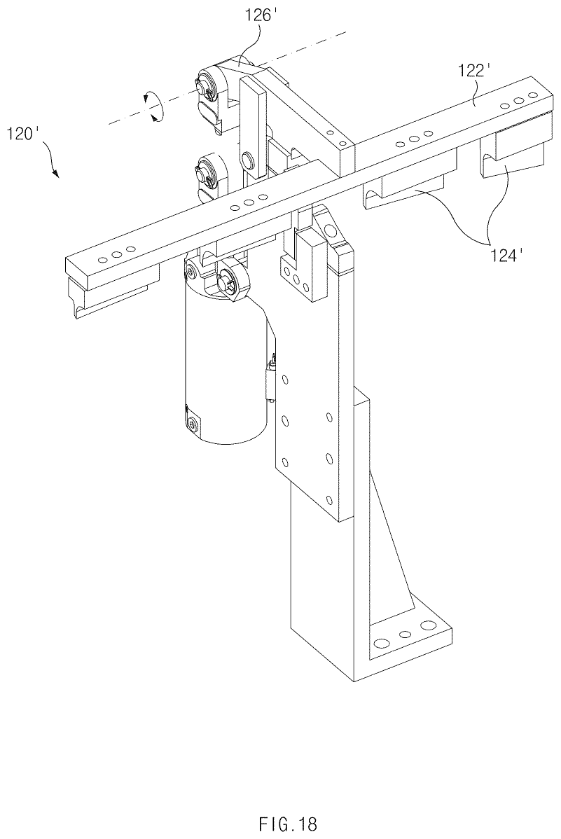

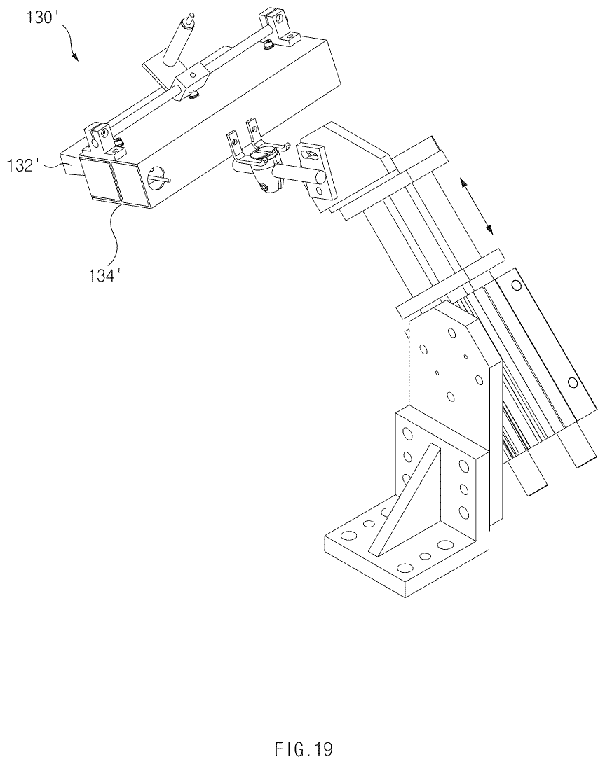

With reference to FIGS. 1-22, an apparatus 100 for combining vehicle components according to an embodiment of the present disclosure includes a base frame 110. The apparatus 100 also includes a pressing part 120 provided on the base frame 110 and configured to press a bonding target component 20 against a vehicle body 10 so that a bonding layer 30 applied onto the bonding target component 20 comes into close contact with the vehicle body 10. The apparatus 100 also includes a heating part 130 provided on the base frame 110 and configured to heat the bonding layer 30 to cure the bonding layer 30.

For reference, the apparatus 100 for combining vehicle components according to the embodiment of the present disclosure may be used to bond various bonding target components 20, which are capable of being bonded to the vehicle body 10, to the vehicle body 10. The present disclosure is not restricted or limited by the type and structure of the bonding target component 20.

For example, the apparatus 100 for combining vehicle components according to the embodiment of the present disclosure may be used to bond a roof panel 20a (bonding target component), which defines an external appearance of a roof of the vehicle body 10, to the vehicle body 10. Alternatively, the apparatus 100 may be used to bond a door panel 20b (bonding target component), which defines an external appearance of a door of the vehicle body 10, to the vehicle body 10 (door).

Hereinafter, an example is described in which the apparatus 100 for combining vehicle components according to the embodiment of the present disclosure is applied to a system for combining vehicle components that couples two different types of bonding target components 20 (e.g., the roof panel 20a and the door panel 20b) to the vehicle body 10.

In the system for combining vehicle components to which the apparatus 100 for combining vehicle components according to the embodiment of the present disclosure is applied, a process of joining the roof panel 20a to the vehicle body 10 and a process joining the door panel 20b to the vehicle body 10 (door) may be performed.

Hereinafter, an example is described in which the apparatus 100 for combining vehicle components according to the embodiment of the present disclosure is used for the process of joining the roof panel 20a.

With reference to FIG. 1, the process of joining the roof panel 20a is performed by a step of chucking the base frame 110 on a carriage robot 50. The process also includes a step of gripping the roof panel 20a, which is supplied to a roof panel alignment jig 40, on the base frame 110 and includes a step of applying the bonding layer 30 onto the roof panel 20a by using a bonding agent application robot 60. The process also includes a step of loading the roof panel 20a, onto which the bonding layer 30 is applied, by the carriage robot 50 onto the vehicle body 10 (loading the roof panel so that the bonding layer comes into close contact with the vehicle body). and includes a step of pressing and heating (curing) the bonding layer 30 by using the pressing part 120 and the heating part 130 provided on the base frame 110. The process also includes a step of separating (releasing) the base frame 110 from the roof panel 20a, and a step of returning the base frame 110 onto a base jig (de-chucking).

The base frame 110 may have various structures in accordance with required conditions and design specifications. The present disclosure is not restricted or limited by the structure and shape of the base frame 110.

For example, the base frame 110 may be provided in the form of an approximately quadrangular box made by combining a plurality of frame members. A chucking part (not illustrated) may be provided at an upper end of an approximate center of the base frame 110 to chuck the carriage robot 50.

According to another embodiment of the present disclosure, the base frame may have a circular shape or any other suitable shape.

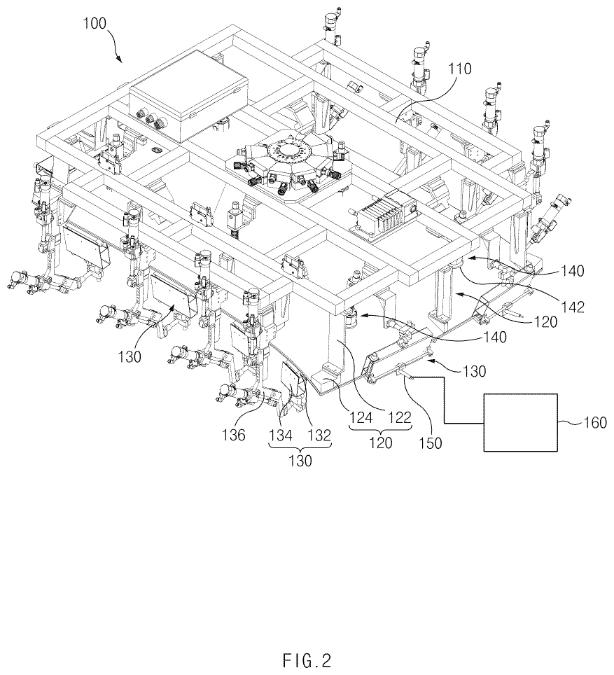

With reference to FIGS. 2-5 and 8, according to an embodiment of the present disclosure, the system for combining vehicle components may include grip parts 140 provided on the base frame 110 and configured to grip the bonding target component 20 (roof panel).

In this case, the configuration in which a grip part 140 of the grip parts 140 grips the bonding target component 20 may be defined as a configuration in which the grip part 140 grips the bonding target component 20 when the grip part 140 may transfer or move the bonding target component 20.

The grip part 140 may grip the bonding target component 20 in various ways in accordance with required conditions and design specifications. The present disclosure is not restricted or limited by the gripping method of the grip part 140.

According to an embodiment of the present disclosure, the grip part 140 may include a suction gripper 142 configured to hold an outer surface of the roof panel 20a by suction.

The suction gripper 142 may have various structures capable of holding the outer surface of the roof panel 20a by vacuum suction. The present disclosure is not restricted or limited by the structure and number of the suction gripper 142.

Hereinafter, an example is described in which a total of six grip parts 140 having corresponding suction grippers 142, each having an approximately circular plate shape, are arranged in a 2 by 3 matrix.

In an embodiment of the present disclosure illustrated and described above, the grip parts 140 grip the roof panel 20a by suction. However, according to another embodiment of the present disclosure, the grip parts 140 may be configured to grip the roof panel by an attaching method, a pressing method, or any other method.

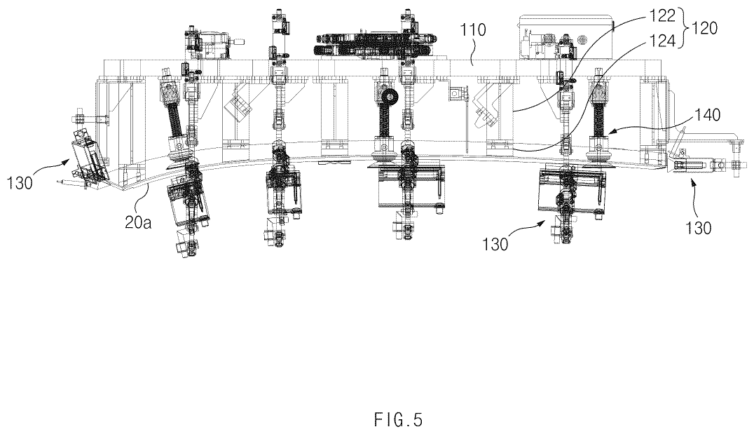

In particular, a suction gripper 142 of the suction grippers 142 may be elastically supported on the base frame 110 to minimize an impact applied to the bonding target component 20 and minimize damage to the bonding target component 20 when the suction gripper 142 comes into contact with the bonding target component 20 (roof panel). For example, the suction gripper 142 may be mounted on the base frame 110 so as to be elastically movable in a direction (an upward/downward direction based on FIG. 5) toward or away from the bonding target component 20 by a spring member (not illustrated).

As mentioned above, the apparatus 100 includes a pressing part 120. The pressing part 120 is provided on the base frame 110 and configured to press the bonding target component 20 against the vehicle body 10 so that the bonding layer 30 applied onto the bonding target component 20 (roof panel) comes into close contact with the vehicle body 10.

The pressing part 120 may have various structures capable of pressing the roof panel 20a against the vehicle body 10 with the bonding layer 30 interposed therebetween. The present disclosure is not restricted or limited by the structure and shape of the pressing part 120.

For example, the pressing part 120 may be configured to press the roof panel 20a against the vehicle body 10 by using the weight of the base frame 110.

According to an embodiment of the present disclosure, the pressing part 120 may include a pressing frame 122 connected to the base frame 110, and a pressing block 124 provided on the pressing frame 122. The pressing block 124 may be configured to come into contact with the bonding target component 20. The pressing block 124 may also be configured to transmit the weight of the base frame 110 to the bonding target component 20.

The pressing frame 122 is connected to a lower end of the base frame 110 in the upward/downward direction (gravitational direction). The present disclosure is not restricted or limited by the structure and shape of the pressing frame 122.

For example, the pressing frame 122 may be provided in the form of an approximately straight bar. Alternatively, the pressing frame 122 may have a curved shape or other shapes.

According to an embodiment of the present disclosure, the pressing part 120 may be provided as a plurality of pressing parts 120 spaced apart from one another along an outermost peripheral edge of the bonding target component 20 (roof panel). Each pressing part 120 may include the pressing frame 122. For example, a total of twelve pressing frames 122 may be provided on the base frame 110 and spaced apart from one another at predetermined intervals along the outermost peripheral edge of the bonding target component 20 (roof panel). Each pressing frame 122 may include the pressing block 124.

The pressing block 124 may be connected to a lowermost end of each pressing frame 122 and configured to come into contact with the bonding target component 20. The weight of the base frame 110 may be transmitted to the bonding target component 20 by the pressing block 124.

In particular, the pressing block 124 may be made of a typical elastic material such as rubber and urethane in order to minimize damage (e.g., scratch) to the bonding target component 20 caused by the contact with the pressing block 124.

The pressing block 124 may have various structures capable of coming into contact with the bonding target component 20 (roof panel). The present disclosure is not restricted or limited by the structure and shape of the pressing block 124.

For example, the pressing block 124 may be configured to come into surface contact with the bonding target component 20 (roof panel). According to another embodiment of the present disclosure, the pressing block may come into line or point contact with the bonding target component (roof panel).

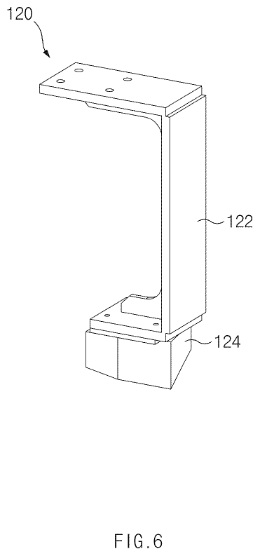

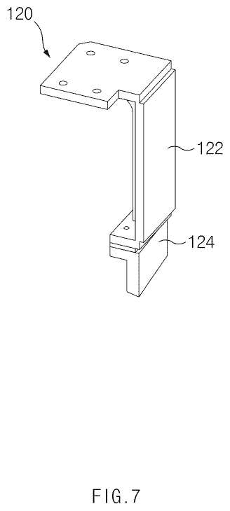

For example, with reference to FIG. 6, the pressing block 124 may be provided in the form of an approximately quadrangular block capable of coming into surface contact with the bonding target component 20 (roof panel). Alternatively, as illustrated in FIG. 7, the pressing block 124 may be configured to have an approximately “L”-shaped cross-sectional design.

For reference, a contact surface (lowermost end surface) of the pressing block 124, which comes into contact with the bonding target component 20 (roof panel), may be provided as a flat or curved surface corresponding to a structure (curvature) of the bonding target component 20 (roof panel). The present disclosure is not restricted or limited by the structure and shape of the contact surface of the pressing block 124.

In particular, the pressing block 124 may be configured to press the outermost peripheral edge of the bonding target component 20 (roof panel).

This is because the bonding layer 30, which is applied onto the bonding target component 20 (roof panel), is formed along the outermost peripheral edge of the bonding target component 20. Because the pressing block 124 presses the outermost peripheral edge portion of the bonding target component 20 corresponding to the bonding layer 30, it is possible to obtain an advantageous effect of minimizing the separation of the bonding target component 20 (roof panel) from the vehicle body 10 and more effectively bringing the bonding layer 30 into contact with the vehicle body 10 and the bonding target component 20.

More particularly, among the plurality of pressing blocks 124 disposed along the outermost peripheral edge of the bonding target component 20, a pressing block 124, which is disposed on a corner portion of the bonding target component 20, may have a relatively large cross-sectional area.

As described above, because a pressing block 124, which is disposed on the corner portion of the bonding target component 20, has the largest cross-sectional area, it is possible to obtain an advantageous effect of more effectively suppressing the separation of the corner portion of the bonding target component 20. Additionally, the configuration stably maintains the arrangement state of the bonding target component 20 with respect to the vehicle body 10 (the close contact state of the bonding layer).

In an embodiment of the present disclosure illustrated and described above, the example has been described in which the pressing part 120 presses the bonding target component 20 against the vehicle body 10 by using the weight of the base frame 110. However, according to another embodiment of the present disclosure, the pressing part may be configured to press the bonding target component against the vehicle body by using driving power of a driving source such as a cylinder, a solenoid, or a motor.

With reference to FIGS. 2-5 and 9, a heating part 130 is provided on the base frame 110 and configured to heat the bonding layer 30 to cure the bonding layer 30.

In particular, the heating part 130 may be configured to heat the bonding layer 30 while the bonding target component 20 is pressed against the vehicle body 10 by the pressing part 120. Alternatively, the heating part 130 may be configured to heat the bonding layer 30 after the bonding target component 20 is pressed against the vehicle body 10 for a predetermined time.

The heating part 130 may have various structures capable of heating the bonding layer 30. The present disclosure is not restricted or limited by the structure and heating method of the heating part 130.

According to an embodiment of the present disclosure, the heating part 130 may include a heat source 132 configured to emit heat for heating the bonding layer 30 and may include a support member 134 connected to the base frame 110 and configured to support the heat source 132.

Various heating means capable of emitting heat may be used as the heat source 132. The present disclosure is not restricted or limited by the type and structure of the heat source 132.

According to the embodiment of the present disclosure, a radiant heat source configured to emit radiant heat toward the bonding layer 30 may be used as the heat source 132.

In particular, an infrared lamp configured to emit infrared rays may be used as the heat source 132.

According to another embodiment of the present disclosure, as the heat source, a lamp configured to emit light other than infrared rays may be used, and a heater or other heating media may be used.

The support member 134 may have various structures capable of supporting the heat source 132 on the base frame 110. The present disclosure is not restricted or limited by the structure and shape of the support member 134.

For example, the support member 134 may have an approximately “U”-shaped cross-sectional design opened at one end thereof. The heat source 132 may be accommodated in the support member 134 so as to emit light through the opening portion of the support member 134.

The heating part 130 may be disposed in various postures and positions in which the heating part 130 may apply heat to an edge of the bonding target component 20 (a point at which the bonding layer is applied). The present disclosure is not restricted or limited by the posture and position of the heating part 130.

According to an embodiment of the present disclosure, the heat part 130 may be provided as a plurality of heat parts 130 spaced apart from one another along an outermost peripheral edge of the bonding target component 20 (roof panel).

With reference to FIG. 2, according to an embodiment of the present disclosure, the pressing parts 120 and the heating parts 130 may be alternately disposed along the edge of the bonding target component 20.

Because the pressing parts 120 and the heating parts 130 are alternately disposed along the edge of the bonding target component 20 as described above, it is possible to obtain an advantageous effect of ensuring a more uniform effect of pressing and curing the bonding layer 30 along the edge of the bonding target component 20.

According to another embodiment of the present disclosure, along the edge of the bonding target component, the pressing parts 120 and the heating parts 130 may be irregularly disposed, or the pressing parts 120 and the heating parts 130 may be disposed on the same line so as to overlap one another (e.g., the pressing parts and the heating parts are disposed side by side).

Each heating part 130 of the heating parts 130 may be fixed in a preset posture to the base frame 110 or configured to be selectively movable.

Hereinafter, an example is described in which the heating parts 130, which are disposed at front and rear ends of the roof panel 20a (ends of the roof panel based on the longitudinal direction of the vehicle body), are fixed in preset postures to the base frame 110. Additionally, the heating parts 130, which are disposed at lateral ends of the roof panel 20a, are configured to be selectively movable.

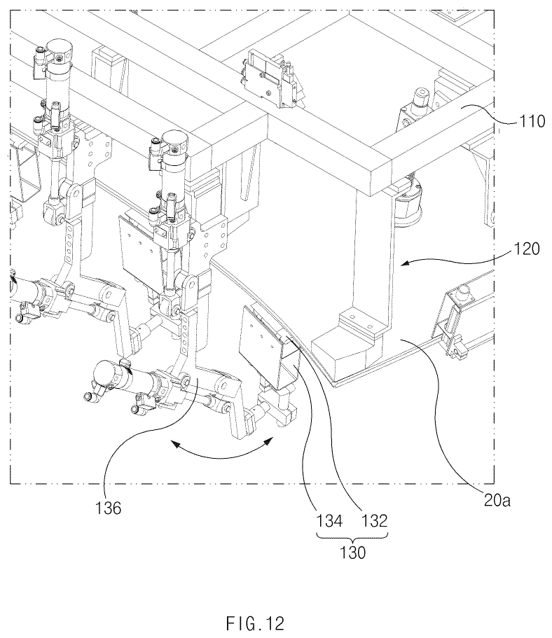

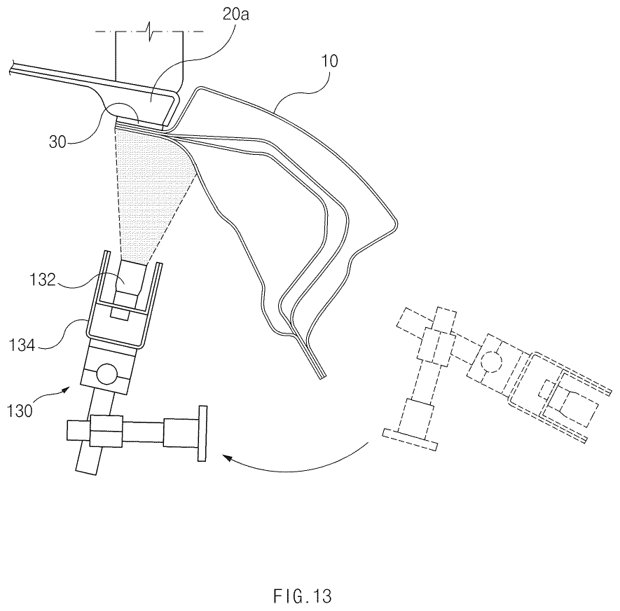

With reference to FIGS. 12 and 13, according to an embodiment of the present disclosure, some of the plurality of heating parts 130 (e.g., the heating parts disposed at the lateral ends of the roof panel) are configured to be selectively movable from a heating standby position at which the heating parts are spaced apart from the bonding target component 20 to a heating position at which the heating parts are moved toward and disposed adjacent to the bonding target component 20.

In this case, the configuration in which the heating parts 130 selectively move from the heating standby position to the heating position are defined as including both a configuration in which the heating parts 130 move from the heating standby position to the heating position along a straight route and a configuration in which the heating parts 130 move along a curved line route.

The above-mentioned configuration is to prevent interference caused by the heating parts 130 when the bonding target component 20 (roof panel) is gripped on the base frame 110 or the base frame 110 is separated (released) from the bonding target component 20. Further, the above-mentioned configuration is to effectively ensure the effect of heating (curing) the bonding layer 30 by the heating parts 130 during the process of heating the bonding layer 30.

In other words, in an embodiment of the present disclosure, during the process of gripping (or releasing) the bonding target component 20 to (or from) the base frame 110, the heating parts 130 move to the heating standby position at which the heating parts 130 are spaced apart from the bonding target component 20. Thus, the bonding target component 20 may be stably gripped on (or released from) the base frame 110 without interference with the heating parts 130. For example, the heating standby position of the heating parts 130 may be defined in an outer region of the base frame 110 in a plan view.

In contrast, during the process of heating the bonding layer 30, the heating parts 130 move to the heating position at which the heating parts 130 are adjacent to the bonding target component 20. Thus, a distance between the heating parts 130 and the bonding layer 30 may be minimized, which may ensure a sufficient heating effect implemented by the heating parts 130. For example, the heating position of the heating parts 130 may be defined in an inner region of the base frame 110 in a plan view.

The movement of the heating parts 130 (the movement from the heating standby position to the heating position) may be implemented in various ways in accordance with required conditions and design specifications.

According to an embodiment of the present disclosure, the apparatus 100 for combining vehicle components may include link members 136 configured to support corresponding heating parts 130 on the base frame 110 so that the heating parts 130 are rotatable. The posture of each heating part 130 with respect to the bonding target component 20 may be selectively adjusted based on the rotation of the corresponding link member 136 relative to the base frame 110.

In this case, the configuration in which the posture of the heating part 130 with respect to the bonding target component 20 is adjusted may be defined as a configuration in which the angle and distance of the heating part 130 (e.g., the heat source) with respect to the bonding target component 20 are adjusted.

The link member 136 may have various structures capable of supporting the corresponding heating part 130 on the base frame 110 so that the heating part 130 is rotatable. The present disclosure is not restricted or limited by the structure of the link member 136.

For example, the link member 136 may be configured by rotatably connecting a plurality of links. In some instances, the link member 136 may include a single link. The present disclosure is not restricted or limited by the number and structure of the link that constitutes the link member 136.

Further, the link member 136 may be configured to be rotated by a typical driving source such as a cylinder. The present disclosure is not restricted or limited by the type and structure of the driving source configured to rotate the link member 136.

The movement of the heating part 130 (the movement from the heating standby position to the heating position) may be performed by a single step or two or more steps.

For example, the heating part 130 positioned at the heating standby position may enter the vehicle body 10 based on a first rotational operation of the link member 136. Then the support member 134 (heat source) may rotate to face an inner surface of the vehicle body 10 based on a second rotational operation of the link member 136, such that the heating part 130 may be disposed at the heating position.

The method of heating the bonding layer 30 by using the heating part 130 may be variously changed in accordance with required conditions and design specifications. The present disclosure is not restricted or limited by the method of heating the bonding layer 30 by using the heating part 130.

According to an embodiment of the present disclosure, the heating part 130 may be configured to heat the vehicle body 10 adjacent to the bonding layer 30, and the bonding layer 30 may be heated by heat Q conducted from the vehicle body 10.

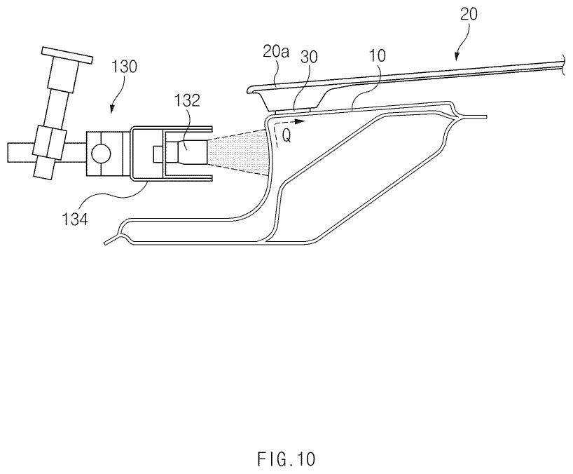

For example, with reference to FIG. 10, the heating part 130 may be configured to heat an outer surface of the vehicle body 10 adjacent to the bonding layer 30. Additionally, the heat applied to the outer surface of the vehicle body 10 is conducted to the bonding layer 30 along the vehicle body 10, such that the bonding layer 30 may be heated (cured).

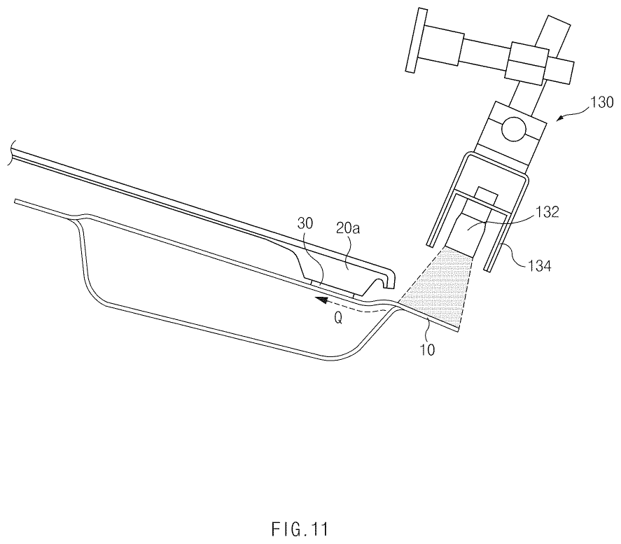

As another example, with reference to FIG. 11, the heating part 130 may be configured to heat an upper surface (outer upper surface) of the vehicle body 10 adjacent to the bonding layer 30. The heat applied to the upper surface of the vehicle body 10 is conducted to the bonding layer 30 along the vehicle body 10, such that the bonding layer 30 may be heated.

As still another example, with reference to FIG. 13, the heating part 130 may be configured to heat an inner surface of the vehicle body 10 adjacent to the bonding layer 30 (e.g., an inner surface of the vehicle body corresponding to the bonding layer). Additionally, the heat applied to the inner surface of the vehicle body 10 is conducted to the bonding layer 30 along the vehicle body 10, such that the bonding layer 30 may be heated.

As described above, in an embodiment of the present disclosure, the heat generated by the heating part 130 is indirectly applied (conducted) to the bonding layer 30 through the vehicle body 10. Therefore, it is possible to obtain an advantageous effect of minimizing damage to and deformation of the bonding target component 20 caused by the heat from the heating part 130. According to another embodiment of the present disclosure, the heat from the heating part may be applied directly to the bonding layer or applied to the bonding layer 30 through the bonding target component.

According to an embodiment of the present disclosure, the apparatus 100 for combining vehicle components may include a sensing part 150 (e.g., a sensor) configured to sense a heating temperature of the bonding layer 30 heated by the heating part 130.

A typical temperature sensor (e.g., a contact temperature sensor or a contactless temperature sensor) capable of sensing a temperature of the bonding layer 30 or a portion adjacent to the bonding layer 30 (e.g., the vehicle body adjacent to the bonding layer) may be used as the sensing part 150. The present disclosure is not restricted or limited by the type and sensing method of the temperature sensor.

The sensing part 150 may be variously changed in mounting position and structure in accordance with required conditions and design specifications. The present disclosure is not restricted or limited by the mounting position and structure of the sensing part 150.

For example, the sensing part 150 may be mounted on the support member 134 and disposed adjacent to the portion to which the heat is applied by the heating part 130 (e.g., the portion irradiated with ultraviolet rays). Alternatively, the sensing part 150 may be mounted on the base frame or mounted at other positions.

According to an embodiment of the present disclosure, the apparatus 100 for combining vehicle components may include an alarm generating part 160 configured to generate an alarm signal when the heating temperature of the bonding layer 30 sensed by the sensing part 150 deviates from a preset reference temperature.

In this case, the alarm signal may include at least one of an auditory alarm signal made by a typical sound means and a visual alarm signal made by a typical warning lamp. In addition, other various alarm signals may be used to inform a user (operator) of a situation in which the heating temperature of the bonding layer 30 is abnormally high.

As described above, when the heating temperature of the bonding layer 30 deviates from the preset reference temperature (e.g., the heating temperature is higher than the reference temperature), the alarm signal is generated, such that the user may stop the abnormal heating situation of the bonding layer 30 in a timely manner. Therefore, it is possible to obtain an advantageous effect of minimizing damage to and deformation of the bonding layer 30 and the bonding target component 20.

With reference back to FIG. 1, according to another embodiment of the present disclosure, an apparatus 100′ for combining vehicle components may also be used for a process of joining the door panel 20b.

For reference, the process of joining the door panel 20b may be performed by a step of applying the bonding layer 30 onto the door panel 20b seated on a door marriage jig 70 by using the bonding agent application robot 60. The process may also include a step of stacking the door (vehicle body) on the door panel 20b so that the bonding layer 30 and the door (vehicle body) come into close contact with each other. The process may also include a step of loading a door assembly, which is made by stacking the door panel 20b and the door, onto a seating part 140′ of a base frame 110′ and may include a step of pressing and heating (curing) the bonding layer 30 by using a pressing part 120′ and a heating part 130′ provided on the base frame 110′. Additionally, the process may include a step of extracting the door assembly from the base frame 110′.

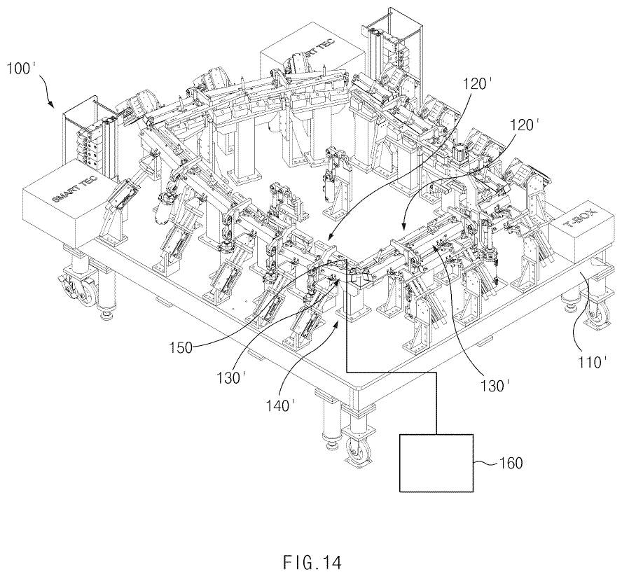

With reference to FIGS. 14-20, the apparatus 100′ for combining vehicle components used for the process of joining the door panel 20b may include the base frame 110′. The apparatus 100′ may also include the pressing part 120′ provided on the base frame 110′ and configured to press the bonding target component 20 against the vehicle body 10 so that the bonding layer 30 applied onto the bonding target component 20 comes into close contact with the vehicle body 10. Additionally, the apparatus 100′ may include the heating part 130′ provided on the base frame 110′ and configured to heat the bonding layer 30 to cure the bonding layer 30. The process of pressing and heating the bonding layer 30 may be performed in the state in which the door assembly, which is made by stacking the door panel 20b and the door (vehicle body), is loaded (mounted) on the base frame 110′.

With reference to FIGS. 14-17, according to an embodiment of the present disclosure, the apparatus 100′ for combining vehicle components may include a seating part 140′ provided on the base frame 110′ and configured such that the vehicle body 10 is seated on the seating part 140′.

The seating part 140′ may have various structures on which the vehicle body 10 (the door assembly made by stacking the door panel and the door) may be seated. The present disclosure is not restricted or limited by the structure of the seating part 140′.

According to the embodiment of the present disclosure, the seating part 140′ may include a plurality of locators 142′ disposed to be spaced apart from one another along the edge of the vehicle body 10.

The locator 142′ may have various structures capable of supporting a lower portion of the vehicle body 10. The present disclosure is not restricted or limited by the structure of the locator 142′.

For example, the locator 142′ may include a locator frame (not illustrated) provided on an upper surface of the base frame 110′, and a locator block (e.g., made of an elastic material such as rubber and urethane) provided at an upper end of the locator frame and configured to define a seating surface on which the vehicle body 10 is seated.

The pressing part 120′ may have various structures capable of pressing the bonding target component 20 against the vehicle body 10 so that the bonding layer 30 applied onto the bonding target component 20 (door panel) comes into close contact with the vehicle body 10 seated on the seating part 140′. The present disclosure is not restricted or limited by the structure and shape of the pressing part 120′.

With reference to FIGS. 14-16 and 18, according to the embodiment of the present disclosure, the pressing part 120′ may include a pressing clamp 122′ provided on the base frame 110′. The pressing clamp 122′ may be configured to be selectively movable from a pressing standby position at which the pressing clamp 122′ is spaced apart from the bonding target component 20 to a pressing position at which the pressing clamp 122′ presses the bonding target component 20. The pressing part 120′ may further include a pressing block 124′ provided on the pressing clamp 122′ and configured to come into contact with the bonding target component 20. The pressing block 124′ may be configured to press the bonding target component 20 against the vehicle body 10 with the bonding layer 30 interposed therebetween.

In this case, the configuration in which the pressing clamp 122′ selectively moves from the pressing standby position to the pressing position is defined as including both a configuration in which the pressing clamp 122′ moves along a straight route from the pressing standby position to the pressing position and a configuration in which the pressing clamp 122′ moves along a curved route.

This is to prevent interference caused by the pressing clamp 122′ (a collision between the pressing clamp and the vehicle body) when the vehicle body 10 (the door assembly made by stacking the door panel and the door) is seated on the seating part 140′.

In other words, in the embodiment of the present disclosure, during the process of loading (or unloading) the bonding target component 20 and the vehicle body 10 (door) onto (or from) the seating part 140′, the pressing clamp 122′ moves to the pressing standby position at which the pressing clamp 122′ is spaced apart from the bonding target component 20. As a result, the bonding target component 20 and the vehicle body 10 may be stably loaded onto (or unloaded from) the seating part 140′ without interference with the pressing clamp 122′.

For example, the pressing standby position of the pressing clamp 122′ may be defined in an outer region of the vehicle body 10 (door) in a plan view. The pressing position of the pressing clamp 122′ may be defined in an inner region of the vehicle body 10 (door) in a plan view.

According to the embodiment of the present disclosure, the pressing clamp 122′ may be configured to be moved (moved from the pressing standby position to the pressing position) by a typical driving source such as a cylinder. The present disclosure is not restricted or limited by the type and structure of the driving source configured to move the pressing clamp 122′.

The pressing clamp 122′ may have various structures in accordance with required conditions and design specifications. The present disclosure is not restricted or limited by the structure and shape of the pressing clamp 122′.

For example, the pressing clamp 122′ may be provided in the form of an approximately straight bar. The pressing clamp 122′ may be provided as a plurality of pressing clamps 122′ spaced apart from one another at predetermined intervals along the edge of the door. Alternatively, the pressing clamp 122′ may have a curved shape or other shapes.

The pressing block 124′ may be provided on the pressing clamp 122′ and configured to come into contact with the bonding target component 20 (or the vehicle body). A pressing force applied by the pressing clamp 122′ may be transmitted to the bonding target component 20 through the pressing block 124′.

For example, the pressing clamp 122′ may have a plurality of pressing blocks spaced apart from one another at predetermined intervals.

In particular, the pressing block 124′ may be made of a typical elastic material such as rubber and urethane in order to minimize damage (e.g., scratch) to the bonding target component 20 caused by the contact with the pressing block 124′.

The pressing block 124′ may have various structures capable of coming into contact with the bonding target component 20 (door panel). The present disclosure is not restricted or limited by the structure and shape of the pressing block 124′.

For example, the pressing block 124′ may be configured to come into surface contact with the bonding target component 20 (door panel). According to another embodiment of the present disclosure, the pressing block may come into line or point contact with the bonding target component (door panel).

The movement of the pressing clamp 122′ (the movement from the pressing standby position to the pressing position) may be implemented in various ways in accordance with required conditions and design specifications.

According to an embodiment of the present disclosure, the apparatus 100′ for combining vehicle components may include a clamp latch 126′ configured to support the corresponding pressing clamp 122′ on the base frame 110′ so that the pressing clamp 122′ is rotatable. The pressing clamp 122′ may be configured to rotate about one end of the clamp latch 126′ from the pressing standby position to the pressing position.

The clamp latch 126′ may have various structures capable of supporting the pressing clamp 122′ on the base frame 110′ so that the pressing clamp 122′ is rotatable. The present disclosure is not restricted or limited by the structure of the clamp latch 126′.

For example, the clamp latch 126′ may be provided in the form of an approximately straight bar. The clamp latch 126′ may be connected to the pressing clamp 122′ to collectively define an approximately “T” shape. The pressing clamp 122′ may move from the pressing standby position to the pressing position by rotating about one end of the clamp latch 126′.

With reference to FIGS. 14-16 and 19-20, the heating part 130′ is provided on the base frame 110′ to heat the bonding layer 30 such as to cure the bonding layer 30.

In particular, the heating part 130′ may be configured to heat the bonding layer 30 while the bonding target component 20 (door panel) is pressed against the vehicle body 10 (door) by the pressing part 120′.

The heating part 130′ may have various structures capable of heating the bonding layer 30. The present disclosure is not restricted or limited by the structure and heating method of the heating part 130′.

According to an embodiment of the present disclosure, the heating part 130′ may include a heat source 132′ (e.g., an infrared lamp) configured to emit heat for heating the bonding layer 30. The heating part 130′ may also include a support member 134′ connected to the base frame 110′ and configured to support the heat source 132′.

The heating part 130′ may be provided in various postures and positions in which the heating part 130′ may heat the bonding layer 30. The present disclosure is not restricted or limited by the posture and position of the heating part 130′.

For example, the heating part 130′ may be disposed approximately in parallel with the pressing clamp 122′ and provided to surround a periphery of a lateral side of the pressing clamp 122′.

Hereinafter, an example is described in which a plurality of heating parts 130′ are spaced apart from one another at predetermined intervals along an outermost peripheral edge of the vehicle body 10 (door) and disposed to surround the periphery of the lateral side of the pressing clamp 122′. For example, the clamp latch 126′ may be rotatably disposed in a space between the adjacent heating parts 130′.

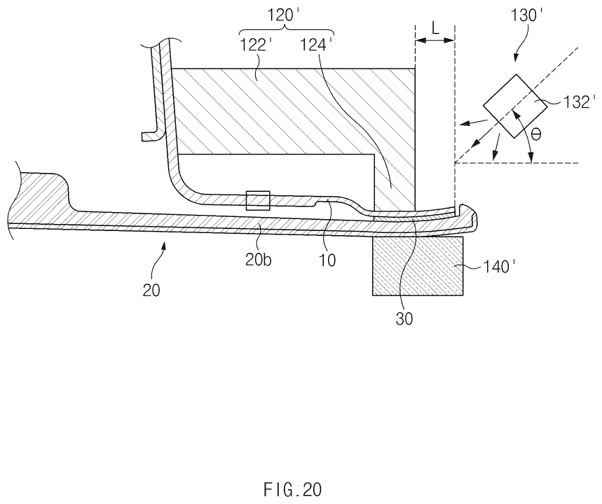

According to an embodiment of the present disclosure, the pressing block 124′ may press the bonding target component 20 at a position spaced apart from the outermost peripheral edge of the bonding target component 20 at a preset reference distance (see L in FIG. 20). The heating part 130′ may be configured to heat the bonding layer 30 in a region between the outermost peripheral edge of the bonding target component 20 and the pressing block 124′.

A direction in which the heat is applied to the bonding layer 30 from the heating part 130′ (e.g., an angle at which ultraviolet rays are emitted) may be variously changed in accordance with required conditions and design specifications. The present disclosure is not restricted or limited by the direction in which the heat is applied from the heating part 130′.

In particular, the direction in which the heat is applied to the bonding layer 30 from the heating part 130′ may be defined to be inclined at a predetermined angle 0 with respect to the bonding layer 30 (horizontal line).

This is to ensure the sufficient effect of heating the bonding layer 30 while minimizing damage to the bonding target component 20 caused by the heat from the heating part 130′. In particular, because an outer surface of the door panel 20b is made of a thermoplastic material, there is a problem in that the outer surface of the door panel 20b is deformed by heat when heat is applied directly to the outer surface of the door panel 20b.

However, in the present disclosure, the direction in which the heat is applied from the heating part 130′ is defined to be inclined at the predetermined angle θ with respect to the bonding layer 30 (the horizontal line based on FIG. 20). Therefore, it is possible to obtain an advantageous effect of minimizing a degree to which the heat from the heating part 130′ is applied directly to the outer surface of the door panel 20b and ensuring the sufficient effect of heating the bonding layer 30.

In particular, an angle at which the heat is applied to the bonding layer 30 (e.g., an angle at which ultraviolet rays are emitted to the bonding layer) may be defined as about 45 degrees with respect to the bonding layer 30.

In an embodiment of the present disclosure illustrated and described above, the example has been described in which the light emitted from the heat source 132′ (infrared lamp) is emitted directly to the portion of the bonding layer 30. However, according to another embodiment of the present disclosure, the light emitted from the heat source may be collected and then emitted to the portion of the bonding layer.

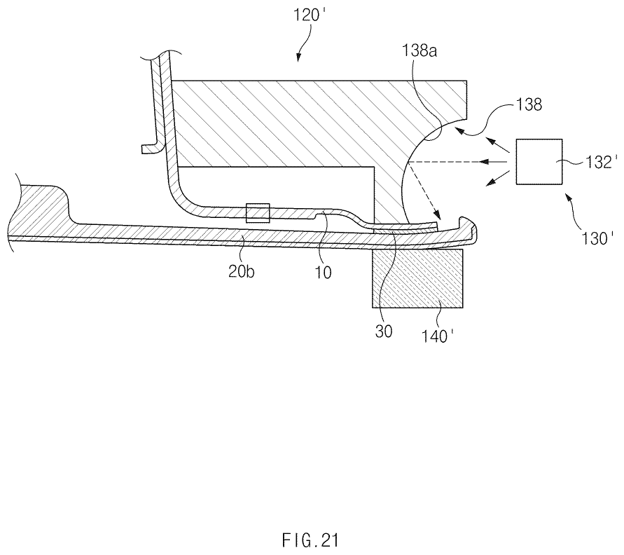

With reference to FIG. 21, according to an embodiment of the present disclosure, the apparatus 100′ for combining vehicle components may include a light collecting part 138 configured to collect the infrared rays, which are emitted from the infrared lamp, toward the bonding layer 30.

The light collecting part 138 may be provided at various positions in accordance with required conditions and design specifications. The present disclosure is not restricted or limited by the position at which the light collecting part 138 is provided.

For example, the light collecting part 138 may be provided at a lateral side of the pressing part 120′ adjacent to the heat source 132′.

The light collecting part 138 may have various structures capable of collecting the infrared rays, which are emitted from the infrared lamp, toward the bonding layer 30. The present disclosure is not restricted or limited by the type and structure of the light collecting part 138.

For example, the light collecting part 138 may include a light collecting surface 138a having an approximately concave shape.

According to another embodiment of the present disclosure, an optical member, such as a lens, may be used to collect the infrared rays, which are emitted from the infrared lamp, toward the bonding layer.

In an embodiment of the present disclosure illustrated and described above, the example has been described in which the bonding layer is pressed by the pressing part provided on the base frame. However, according to another embodiment of the present disclosure, the bonding layer may be pressed by molds.

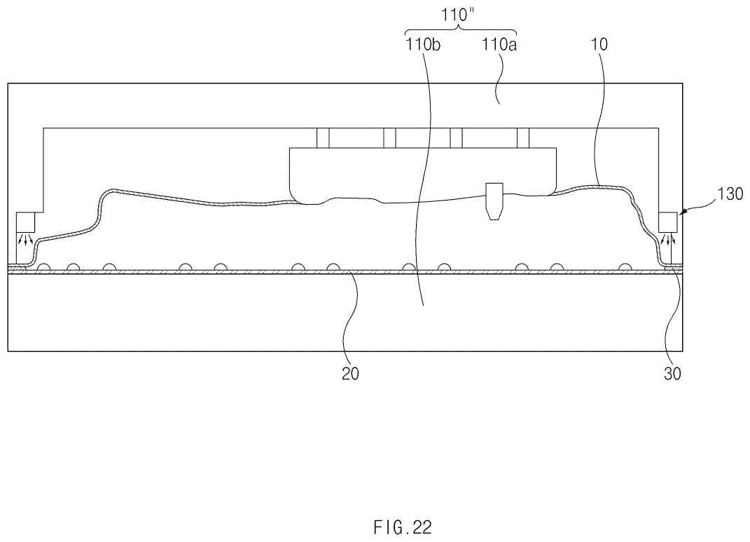

With reference to FIG. 22, according to an embodiment of the present disclosure, a base frame 110″ may include a lower mold 110b configured to support the bonding target component 20, and an upper mold 110a provided above the lower mold 110b and configured to press the vehicle body 10 against the bonding target component 20. The heating part 130 may be provided at an edge portion of the upper mold 110a and configured to heat the bonding layer 30 applied between the vehicle body 10 and the bonding target component 20.

According to the present disclosure described above, it is possible to obtain an advantageous effect of improving quality, productivity, and production efficiency.

In particular, according to an embodiment of the present disclosure, it is possible to obtain advantageous effects of simplifying the process of joining the composite material component and the vehicle body while ensuring the joining quality between the composite material component and the vehicle body.

Among other things, according to an embodiment of the present disclosure, the single apparatus for combining vehicle components may perform, in an integrated manner, the process of pressing the composite material component against the vehicle body and the process of heating the bonding layer.

In addition, according to an embodiment of the present disclosure, it is possible to obtain an advantageous effect of simplifying the structure and manufacturing process and improving the spatial utilization and degree of design freedom.

In addition, according to an embodiment of the present disclosure, it is possible to obtain an advantageous effect of reducing a defect rate and improving the durability and reliability.

While various embodiments have been described above, the embodiments are illustrative only and not intended to limit the present disclosure. It should be appreciated by those having ordinary skill in the art that various modifications and applications, which are not described above, may be made to the embodiments of the present embodiment without departing from the intrinsic features of the disclosed embodiments. For example, the respective constituent elements specifically described in the embodiments may be modified and then carried out. Further, it should be interpreted that the differences related to the modifications and applications are included in the scope of the present disclosure defined by the appended claims.

What is claimed is:

1. An apparatus for combining vehicle components, the apparatus comprising:
a base frame;
a pressing part provided on the base frame and configured to press a bonding target component against a vehicle body so that a bonding layer applied onto the bonding target component comes into close contact with the vehicle body; and
a heating part provided on the base frame and configured to heat the bonding layer to cure the bonding layer.

2. The apparatus of claim 1, wherein the pressing part comprises:
a pressing frame connected to the base frame; and
a pressing block provided on the pressing frame and configured to come into contact with the bonding target component,
wherein the pressing block is configured to transmit a weight of the base frame to the bonding target component.

3. The apparatus of claim 2, wherein the bonding layer is provided along an outermost peripheral edge of the bonding target component, and wherein the pressing block is configured to press an outermost peripheral edge portion of the bonding target component corresponding to the bonding layer.

4. The apparatus of claim 1, wherein the pressing part comprises:
a pressing clamp provided on the base frame and configured to be selectively movable from a pressing standby position at which the pressing clamp is spaced apart from the bonding target component to a pressing position at which the pressing clamp presses the bonding target component; and
a pressing block provided on the pressing clamp and configured to come into contact with the bonding target component,
wherein the pressing block is configured to press the bonding target component against the vehicle body with the bonding layer interposed therebetween.

5. The apparatus of claim 4, comprising:
a clamp latch configured to support the pressing clamp on the base frame so that the pressing clamp is rotatable,
wherein the pressing clamp is configured to rotate about one end of the clamp latch from the pressing standby position to the pressing position.

6. The apparatus of claim 5, wherein the pressing block presses the bonding target component at a position spaced apart from an outermost peripheral edge of the bonding target component at a preset reference distance, and wherein the heating part heats the bonding layer in a region between the outermost peripheral edge of the bonding target component and the pressing block.

7. The apparatus of claim 1, wherein the heating part comprises:
a heat source configured to emit heat for heating the bonding layer; and
a support member connected to the base frame and configured to support the heat source.

8. The apparatus of claim 7, wherein the heat source comprises an infrared lamp.

9. The apparatus of claim 8, comprising:
a light collecting part configured to collect infrared rays, which are emitted from the infrared lamp, toward the bonding layer.

10. The apparatus of claim 7, wherein the heating part is configured to be selectively movable from a heating standby position at which the heating part is spaced apart from the bonding target component to a heating position at which the heating part is adjacent to the bonding target component.

11. The apparatus of claim 10, comprising:
a link member configured to support the heating part on the base frame so that the heating part is rotatable,
wherein a posture of the heating part with respect to the bonding target component is selectively adjusted based on a rotation of the link member relative to the base frame.

12. The apparatus of claim 1, wherein the heating part is configured to heat the vehicle body adjacent to the bonding layer, and wherein the bonding layer is heated by heat conducted from the vehicle body.

13. The apparatus of claim 1, comprising:
a sensing part configured to sense a heating temperature of the bonding layer heated by the heating part.

14. The apparatus of claim 13, comprising:
an alarm generating part configured to generate an alarm signal when the heating temperature of the bonding layer sensed by the sensing part deviates from a preset reference temperature.

15. The apparatus of claim 1, comprising:
a grip part provided on the base frame and configured to grip the bonding target component.

16. The apparatus of claim 15, wherein the grip part comprises a suction gripper configured to hold an outer surface of the bonding target component by suction.

17. The apparatus of claim 1, comprising:
a seating part provided on the base frame and configured such that the vehicle body is seated on the seating part.

18. The apparatus of claim 17, wherein the seating part comprises a plurality of locators disposed to be spaced apart from one another along an edge of the vehicle body.

19. The apparatus of claim 1, wherein the bonding target component comprises a roof panel configured to define a roof of the vehicle body.

20. The apparatus of claim 1, wherein the bonding target component comprises a door panel configured to define a door of the vehicle body.
